(19) United States
(12) Patent Application Publication
(10) Pub. No.: US 2007/0180356 A1
(43) Pub. Date: Aug. 2, 2007

(54) Content that is searchable but inhibited

(76) Inventor: Yu Sun, Salt Lake City, UT (US)

Correspondence Address: PETER K. TRZYNA, ESQ., P O BOX 7131, CHICAGO, IL, 60680, US

(21) Appl. No.: 11/580,742

(22) Filed: Oct. 12, 2006

Related U.S. Application Data
(63) Continuation-in-part of application No. 60/725,955, filed on Oct. 12, 2005.

(51) Int. Cl. G06F 17/00; H04L 9/32; G06F 17/30

(52) U.S. Cl. 715/511; 726/27; 707/3; 715/531

(57) ABSTRACT

A method implemented with a machine, the machine, and the method for using the machine, and products produced thereby. A representative system is programmed to respond to a search engine by testing whether a user is authorized to receive one of two versions of the content, and if there is authorization, the system provides a version of the content that comprises data in order; and if there is not authorization, the system provides a version of the content that comprises a different order of at least some of the data and facilitates authorization.

### I. PRIORITY STATEMENT

This patent application is a continuation in part of, claiming priority and incorporating by reference from, U.S. Patent Application Ser. No. 60/725,955 filed Oct. 12, 2005, by the same inventor, titled “Internet Services.”

### II. TECHNICAL FIELD

The technical field is computers and data processing systems. Depending on the implementation, there is apparatus, a method for use and method for making, and corresponding products produced thereby, as well as data structures, computer-readable media tangibly embodying program instructions, manufactures, and necessary intermediates of the foregoing, each pertaining to digital aspects of network communication, such as over an Internet-type network, e.g., by way of, or inclusive of, such as a web page, advertising, etc.

### III. BRIEF DESCRIPTION OF THE DRAWINGS

FIG. 1 illustrates an embodiment.

### IV. MODES

The accompanying drawings are intended to illustrate and exemplify in a teaching manner. Therefore, embodiments used to carry out the teaching should not be viewed as limiting, but rather, should be viewed as instructively building to an overall teaching.

As used herein, the term “computer” or “computer system” generally refers to hardware or hardware in combination with one or more program(s), such as can be implemented in software. Computer aspects can be implemented on general purpose computers or specialized devices, and can operate electrically, optically, or in any other fashion. A computer as used herein can be viewed as at least one computer having all functionality or as multiple computers with functionality separated to collectively cooperate to bring about the functionality. Logic flow can represent signal processing, such as digital data processing, communication, or as evident from the context hereinafter. Logic flow can be implemented in discrete circuits. Computer-readable media, as used herein can comprise at least one of a RAM, a ROM, a disk, an ASIC, and a PROM. Industrial applicability is clear from the description, and is also stated below.

By way of the following prophetic teaching, there is provided computer (and support thereof), as in a data processing system, for implementations pertaining to embodiments herein, as well as related or necessary computer support such as for allowing a search engine to search web pages with inhibited content, or even without revealing the content. For example, for web pages that require authorization or authentication, the web site does not want un-authorized visitors accessing its pages. However, for different reasons, such as web promotion and web-based citation, some websites would prefer to allow search engine to be able to search and find the web page contents. Inhibited content on a web page can be utilized, and ways to inhibit the content from being readily comprehensible to a human is to scramble or encrypt the contents. One embodiment can use an algorithm that can be used to automatically change the order of words. Another embodiment can automatically change the order of sentences. As to either of these embodiments, some or all of the words can be handled in the corresponding way. In such embodiments, the words can be scrambled prior to, or after, the visitor reaches the website. Such embodiments enable the content to be findable to search engines but in a manner that is inhibited, or even not at all, to humans.

There are many ways and many formats for generating web contents. Consider as a teaching example: a web page can be just an html file a.html (though this approach can be extended to the other formats easily). Suppose that a.html has content that the website only allows authorized visitors to visit. Subscribers need to login or have a cookie or other feature to be able to access the content. Those who are not subscribers do not have the cookie or feature(s) or login username or password.

When a visiting request comes to the web server, if the server detects that the visitor is a subscriber, the server provides the page a.html to the visitor. If not, the server starts a script to generate a b.html, which has a redirect link. The redirect link can have a delay for a predetermined time, such as up to 5 seconds, up to ten seconds, ten to thirty seconds, or greater, or another delay scheme can be used, e.g., a delay in a range, such as a range of 5-10 seconds. For redirection delay timing, e.g., to give a visitor only a glimpse at the content, some search engines may treat redirection web pages as spam web pages if the redirection time is set to less then 10 seconds, because some websites provide “gateway pages” to get high ranking. The “gateway pages” contains well arranged words for search engine and a redirection. The redirection redirects to the main home page.

The redirect herein utilized can be a redirect to a.html in the header (or not, depending on the website's preference). In some embodiments, b.html can contain the first paragraph of the content in a.html (depending on the website's preference), a link to a.html and a sentence-scrambled or word-scrambled (either, both, or otherwise, e.g., encrypted, depending on the website's preference) content of a.html. Such as the file a.html has:

“There are many ways and many formats the web contents can be generated. To describe the method in a simple way, here we use text file a.html as an example. The method can be extended to the other formats easily.

Suppose a.html is a content that the website W only allow authorized visitor to visit, such as the a.html is a content, that is only available to subscribers. Suppose the subscribers need to login, has a cookie or any other features to be able to access this content. Un-subscribers do not have those features or login username or password.”

The generated sentence-scrambled b.html content will be

“The webpage you request requires authorization, If you want to continue, please click on a.html (a link). The following is the first paragraph of the web page.

There are many ways and many formats the web contents can be generated. To describe the method in a simple way, here we use text file a.html as an example. The method can be extended to the other formats easily.

Un-subscribers do not have those features or login username or password. that the website W only allow authorized visitor to visit, has a cookie or any other features to be able to access this content such as the a.html is a content that is only available to subscribers. Suppose a.html is a content, Suppose the subscribers need to login,”

The generated word-scrambled b.html content will be

“The webpage you request requires authorization. If you want to continue, please click on a.html (a link). The following is the first paragraph of the web page.

There are many ways and many formats the web contents can be generated. To describe the method in a simple way, here we use text file a.html as an example. The method can be extended to the other formats easily.

available such have or that or. that the subscribers W only allow visitor do to visit, has a those cookie or any other password Suppose need website features login to be able to access this content. as the a.html is a not Un-subscribers login content is features only to username subscribers. Suppose a.html is a content, the to authorized,”

In the example, the first paragraph is not inhibited or scrambled, so that a visitor can read the content as the introduction of the page. This implementation, of course, is optional, depending on the web site's preference.

Both sentence-scrambled and word-scrambled b.html content are readily readable for finding by search engines, but inhibited so as to be not so readily readable to human visitors. Word-inhibited text is suitable for keyword searches. Sentence-inhibited text is suitable for keyword searches and phrase searches. Encryption is even more inhibited, and in such an embodiment a key for key encryption (any of many types of encryption can be used) can be provided during the authorization process discussed in greater detail herein.

The web site can also use a re-direct link in a header to automatically redirect the visitor to page a.html. In such an embodiment, the human visitor will not see the inhibited content, but search engine will see the content.

Both sentence-inhibited (or encrypted) and word-inhibited (or encrypted) files can be generated with perl, php, c or another program. The algorithm can be random or some special algorithm, e.g., for encryption, depending on the implementation preference. For an sentence-inhibited (or encrypted) version, one algorithm can keep the word order between sentence characters unchanged and reorder the sentences. For a word-inhibited (or encrypted) version, the algorithm can keep the letter order in each word untouched and reorder the words. The inhibited or encrypted file can be generated on-fly or off line and can be stored in one or more directories that do not require authorization or in any way in which the files are reachable by a search engine, such as Google.

With further regard to the redirect, one can generally think of three types of search engines: Crawler-based search engines; human-powered submission search engines; and hybrids of the two. Crawler-based search engines can use software agents to visit web sites and read the information thereon. The information includes meta tags, content in the web pages, and also the links, which are followed to find further information. A crawler can begin with a popular site, indexing the words on its pages and following every link found within the site. Some crawlers also search along directories, from the top directory of the web site to lower level directories. The inhibited web pages discussed herein can be stored in directories open to search engine to be found by search crawlers.

To let a crawler follow the correct links in the web pages, the links should be either kept as they are or replaced to reflect the location of the inhibited web pages. Such as for all web pages, a link to path1/a.html should be replace to path2/b.html, if b.html is the scrambled version of a.html. “path1” is the path to a.html and “path2” is the path to b.html. There are many existing ways to implement the foregoing, e.g., by utilizing open-source code such as nph-proxy.cgi.

Consider the following teaching example of the human comprehension inhibiting/facilitating versions of content illustrated in the coding below.

login.pl:

(The login.pl checks whether there is a valid cookie in the request. If there is, the normal text of file out.html will be sent back to user. If there is not, the out.html will be encrypted and sent be to user with a redirection header. The redirection links to newlogin.pl.)

login.pl:
(The login.pl checks whether there is a valid cookie in the request. If there
is, the normal text of file out.html will be sent back to user. If there is
not, the out.html will be encrypted and sent be to user with a redirection
header. The redirection links to newlogin.pl.)
#!/usr/bin/perl -wT
use CGI;
$aa=“demo”;
$bb = “search”;
open(INF,“out.html”);
my @ary = <INF>;
close(INF);
print “Content-type: text/html\n\n”;
my $query = CGI−>new;
my $cookie_in = $query−>cookie(“DEMO_COOKIES”);
if($cookie_in) {

&normalDisplay( );

}
else {

&encodedDisplay( );

}
print “<br><br>$cookie_in <br>”;
print “</body></html>\n”;
sub normalDisplay{

foreach my $line (@ary) {

print $line;
print “<br>\n”;

}

}
sub encodedDisplay{
print “ <HEAD> ”;
print “<META HTTP-EQUIV=\“Refresh\” CONTENT=\“5;
URL=newlogin.pl\”>”;
print “</HEAD> \n”;

$wholeline = “”;
foreach my $line (@ary) {

$wholeline = $wholeline.$line;

}
@sentences = split(/\./, $wholeline);
@words = split(//, $wholeline);
$size = @sentences;
@sortsentence = sort(@sentences);
@sortwords = sort(@words);
foreach my $sen (@sortwords) {
#foreach my $sen (@sortsentence) {

print $sen;
print “. ”;

}

}
newlogin.pl (The code enables a user login.)
#!/usr/bin/perl
$thisscript = “givecookies.pl”;
print “Content-type: text/html\n\n”;
print “<html><head>\n”;
print “<title>Login</title></head>”;
print “<form method=post action=\“$thisscript\”>”;
print “Name: <input type=text name=username><br>\n”;
print “Password: <input type=password name=pass><br>”;
print “<input type=submit value=Submit name=submit></form>”;
print “</body></html>”;
givecookies.pl (After the login, a cookie is give to the user, and the user is
redirected to login.pl. Because this time, the user has the cookie, the
normal content version of out.html is sent to user after a call to login.pl.)
#!/usr/bin/perl -wT
use CGI qw(:standard);
use CGI::Carp qw(warningsToBrowser fatalsToBrowser);
use strict;
my %form;
my $flag = 0;
my $name = “aa”;
foreach my $p (param()) {

$form{$p} = param($p);
if ($form{$p} eq “demo”)
{ $flag = 1; $name =$form{$p}}

}
if ($flag ==1){

print “Set-Cookie: DEMO_COOKIES = demo\n”;

}
print “Content-type: text/html\n\n”;
print “ <HEAD> ”;
print “<META HTTP-EQUIV=\“Refresh\” CONTENT=\“3;
URL=login.pl\”>”;
print “</HEAD> \n”;
if ($flag ==1){

print “username = $name \n”;

}

In such an example, a login.pl returns to user a generated html web page, in this case, with perl. The page fetches to determine whether there is an authorization cookie on the user side. If there is not such cookie, the script generates the html content which has the encrypted content (see below, which is the encrypted content of out.html) and a redirection link.

<HEAD> <META HTTP-EQUIV=“Refresh” CONTENT=“5; URL=newlogin.pl”></HEAD>
affect.
are.
decrease.
from.
hard.
image.
important.
Image.
it.
noise.
Contrast:.
not.
number.
original.
path.
result..
target.
the.
to.
values.
Cascadeing:. According. According. Answeres:
How. As. But. But. Caculate. From. General. How. I. I. I. If. Image. In. In. In. It. It. It. My. My.
Need. Questions. Size:. The. ‘‘good”, a. a. a. above.. according. accuracy. accuracy. accuracy.
accuracy. accuracy,. added. algorithm. and. and. are. are. as. as. at. automatic. average.
average. back. bad. because. behave. between. caculate. can. can. can. can. cascade. center.
code. code. code,. code,. computing. control. control. control. control. control. control. control.
control. control. corection.. corner. corner. distance. does. does. does. each. each. edge..
experiments. find,. from. gamma. gamma. gave. get. get. get. get. go. good. good.. have. have.
how. image. image. image. image. image,. image,. image.. images. images?
A:. important.. in. in. increase. is. is. is. is. is. it. it. it. it. its. long. makes. many. many. mapping.
matrix. me. minimum. more. more. more. more. more. mosaicing. my. my. necessary. noise..
noise.. noise.
3.. not. not. not. of. of. of. of. of. of. of. origanla. out. out. pading. path. pixel. pixel. pixel. pixel.
points. points. points. points. points. points. points. points. points. points,. points.. points.
Feathering:. points?
A:. positions. positions,. precise,. precise.. random. rate. reason. relation. resample. resample..
results?
A:. search. shown. speaking,. take. target. target. target. the. the. the. the. the. the. the. the. the.
the. the. the. the. the. the. the. the. the. the. the. the. the. the. the. the. the. the. the. the. the. the.
the. the. the. the. then. then. theoretical. time.
2.. to. to. to. to. to. to. to. to. to. to. to. transformation. transformations. use. usually,. value.
value. versa.. very. very. very. vis. weight. white. white. white. will. will. with. your. <br><br>
<br></body></html>

The automatic redirection is, for this example, set to 5 seconds, which redirects to newlogin.pl. The newlogin.pl is a login page. If the user logins in, the page will bring the un-encrypted content (origianllogin.pl) to user.

Responsive to user authorization, a cookie is sent to the visitor's device, e.g., the visitor's browser. If the user returns to the web site again with the valid cookie, the visitor will be shown the un-encrypted content directly (see example below), which is the content of the out.html:

Image Mosaicing Questions and Answers:

How many control points does it take to get a “good” transformation between images?

A: General speaking, as long as the control points are very precise, it is not necessary to have many points. But because usually, it is hard to have the accuracy control points, more control points can decrease the white noise. But more points will increase computing time.

2. How does the algorithm behave at the theoretical minimum of the number of control points?

A: As shown above. It is not good. The reason is the control points are not very precise. Need more points to average out the white noise.

3. From your experiments how does the accuracy of the control points affect the results?

A: In the accuracy image, I added in random noise. It gave me a bad result. the accuracy of the control points is very important. If can not get good accuracy, then more points can average out the white noise.

Contrast: In my code, I use the gamma automatic correction. Calculate the gamma rate according to the pixel value of the control points.

Feathering: In my code, I weight the pixel value with its distance to the edge. It makes the pixel in the center of the image are more important.

Image Size: My code calculates the mapping corner positions of each image to the target image. According the corner positions, pading the target image, then resample the original images to get the pixel values.

Cascading: My code can search the relation matrix to get a path from each image to the target image and vise versa. According the path it find, it will cascade the transformations to go back the original image from the target to resample.

Suppose, as a further teaching example, that a person is searching with some keywords that are in the webpage of the example above, and he or she uses a common search engine such as Google. Such a search engine tries to fetch the page with the example. Because the search engine cannot provide the authorization information that is required to get access to the readily readable page version; instead, the search engine gets the inhibited or encrypted version of the webpage shown in the example. In this example, all the words in the web page shown in the web page example (though less or more words can be used as may be preferred in one embodiment or another). The search engine finds the matching words and provides a link to the person using the search engine. Then the person can click on the link. If the end user's browser has a valid authorization cookie, the end user will be directed to the page with the uninhibited or unencrypted text. If the person's web browser does not have a valid cookie for the authorization, the person will be directed to the inhibited or encrypted webpage version, which has a redirection link to direct the person to a login page.

These approaches can be adapted to do one or more of the following:
1. Allow a website, that wants visitors to login to access the content, to use search engine to promote their website;
2. Allow subscribers (e.g., with authorized cookies) to use general search engines to search the content and see the search result seamlessly; and/or
3. Do not allow web content to be readily viewable to the public through search engines, even search engines have cache functions.

The uninhibited or unencrypted version can also enable downloading to a user station 100. In such embodiments, a visitor may be unable to comprehend availability of downloading, or what is available for downloading, unless authorized.

The inhibited or encrypted web page can also be generated before hand. When an a.html in authorization request place is generated, an inhibited or encrypted version of it, b.html, can be generated in an unprotected location with a link to a.html. So, when a search engine reaches b.html, the search engine searches the content in b.html. When a user researches the b.html either through a search engine or other methods, the user can link to a.html manually by clicking the link, automatically by redirection, or other ways, if the user meets the authorization request.

Note that it is not necessary to just change the order of the words or sentences as other embodiments can be utilized. For example, some words can be repeated in the inhibited version. Or conversely, some words that occur more than 1 time in the uninhibited version need not appear more than one time in the inhibited or encrypted text; and similarly, these particular ideas can be applied to embodiments used for sentences.

Also, it is possible that, when a search engine reviews a page, the search engine may not review the entire document. Instead, it is possible for the search engine to review only, say, the first few hundred characters of text. So, the words in the front or even the entire document need not include common words such as “a”, “the”, “of”, etc. The words can be ordered in their appearance frequency in the text. Any way, there are many ways to carry out allowing a search engine to find the web page, but inhibiting human comprehension of that page.

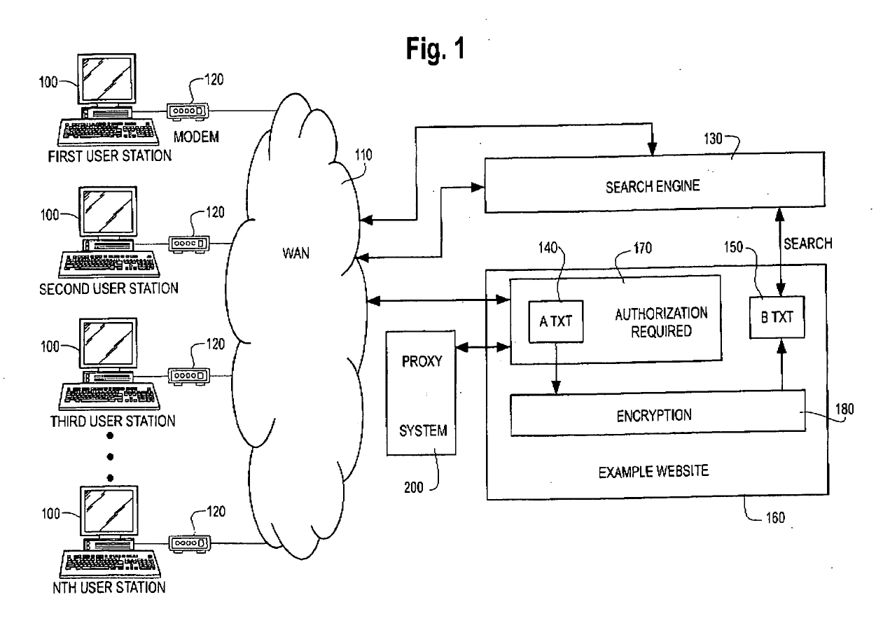

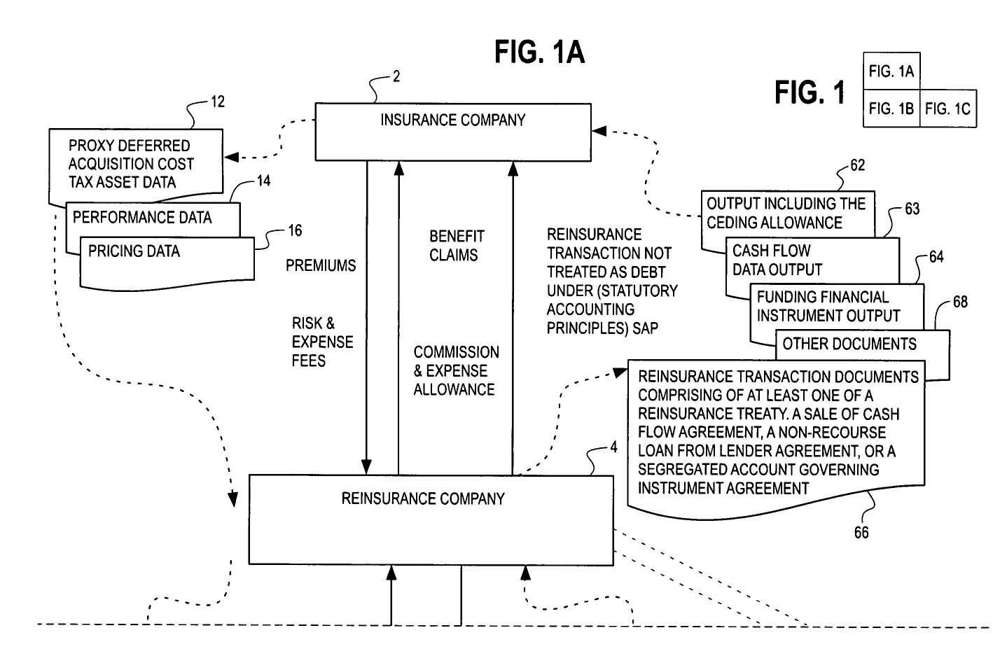

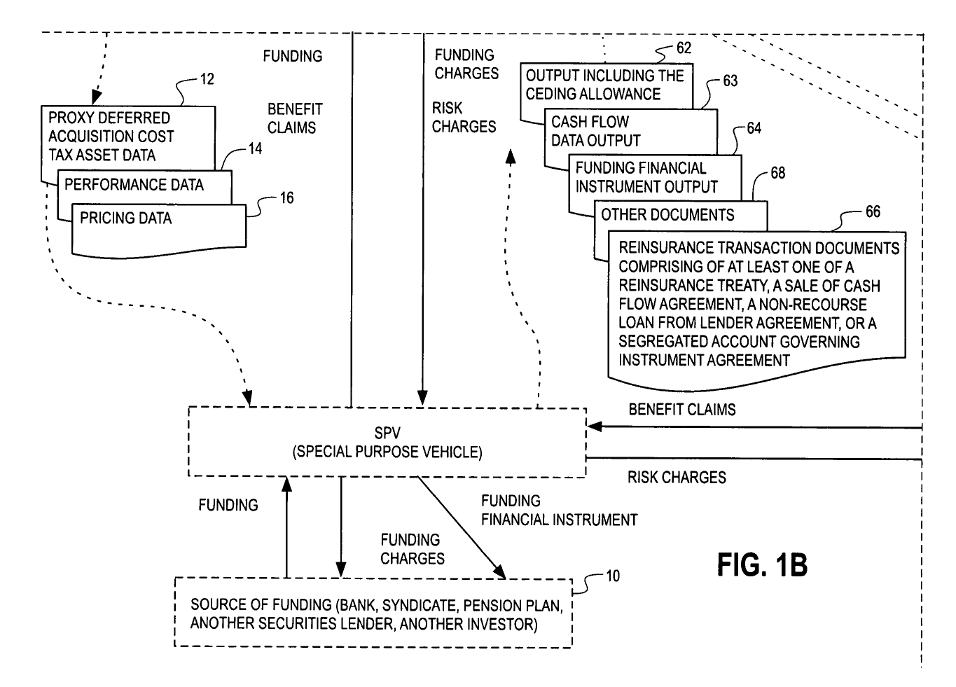

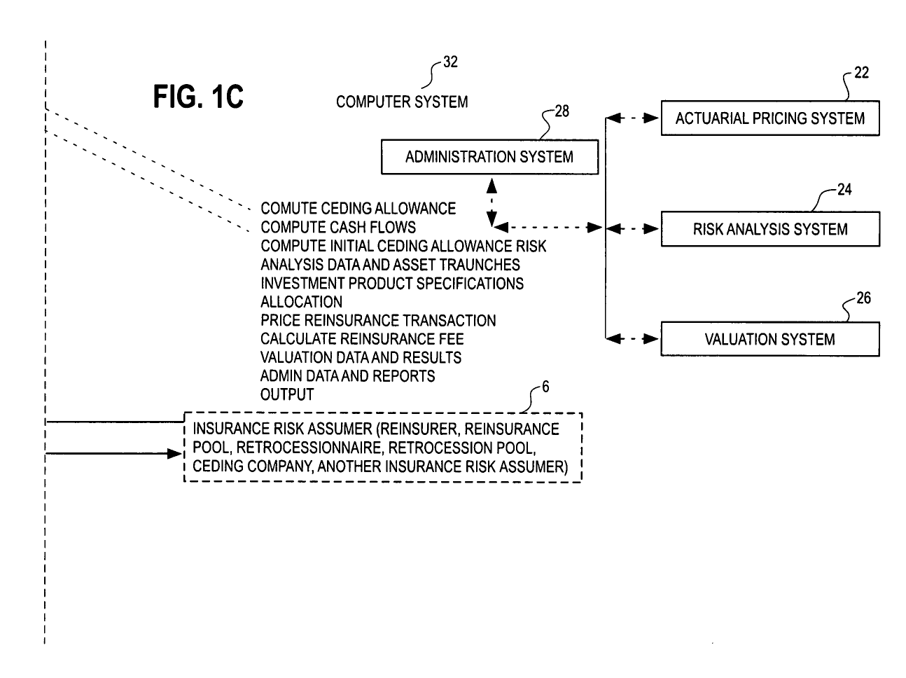

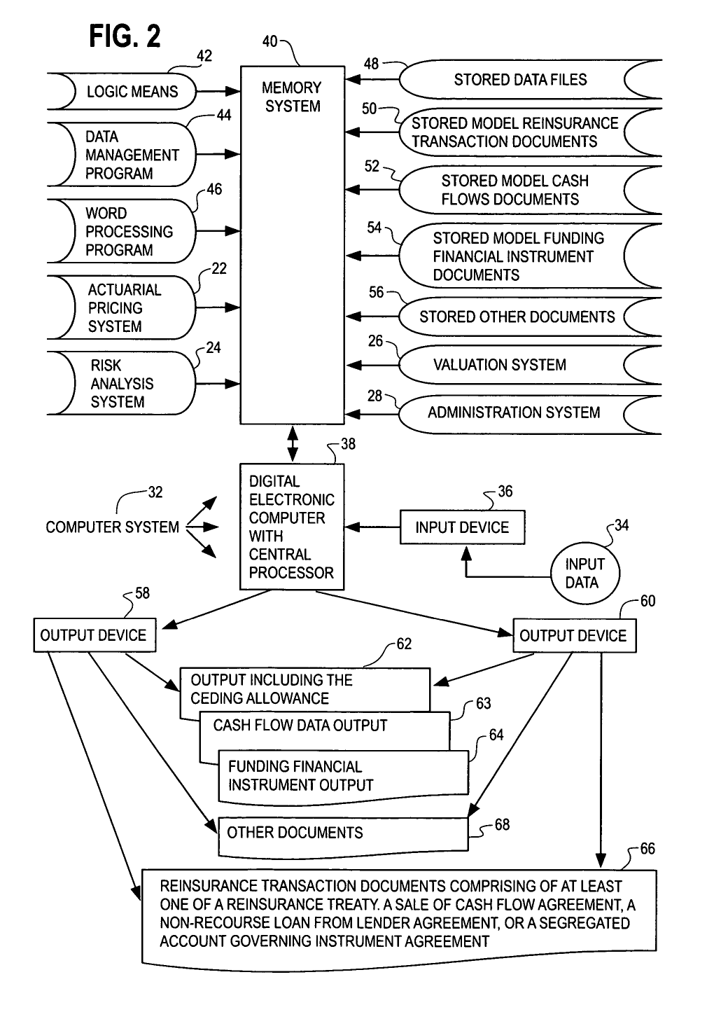

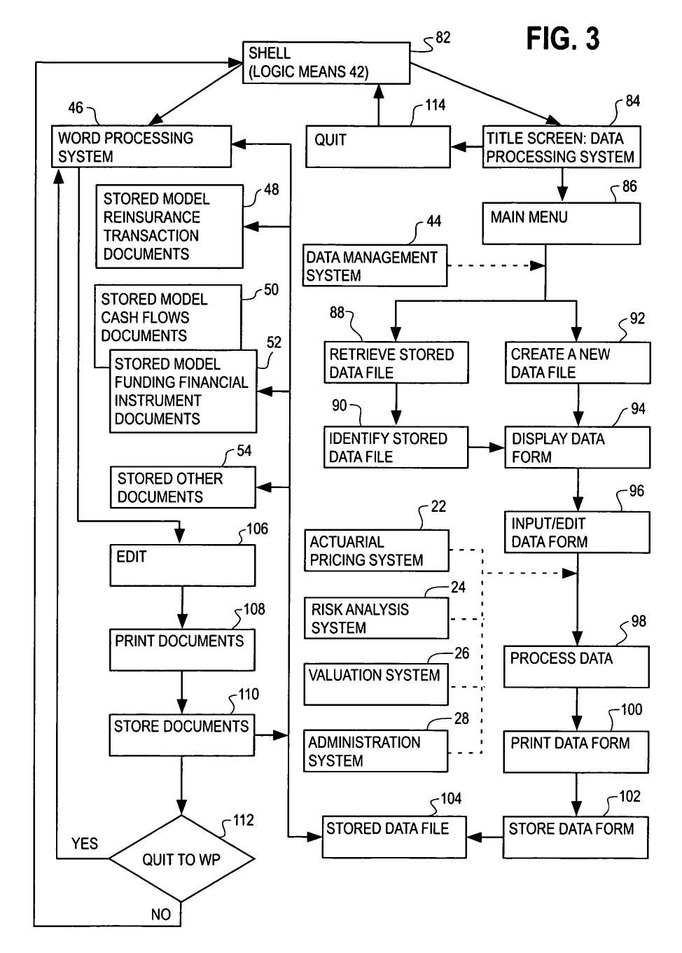

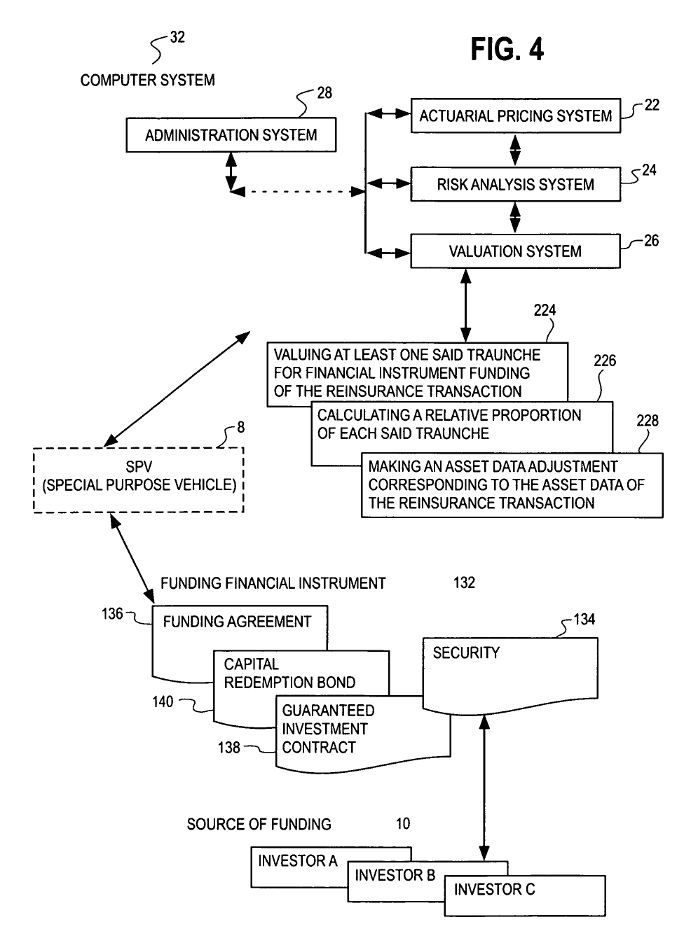

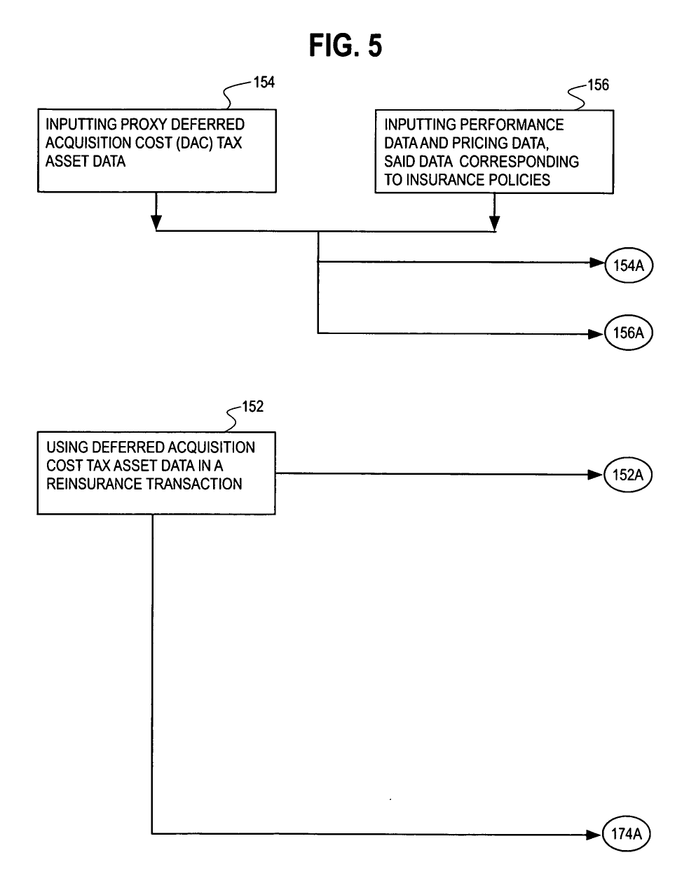

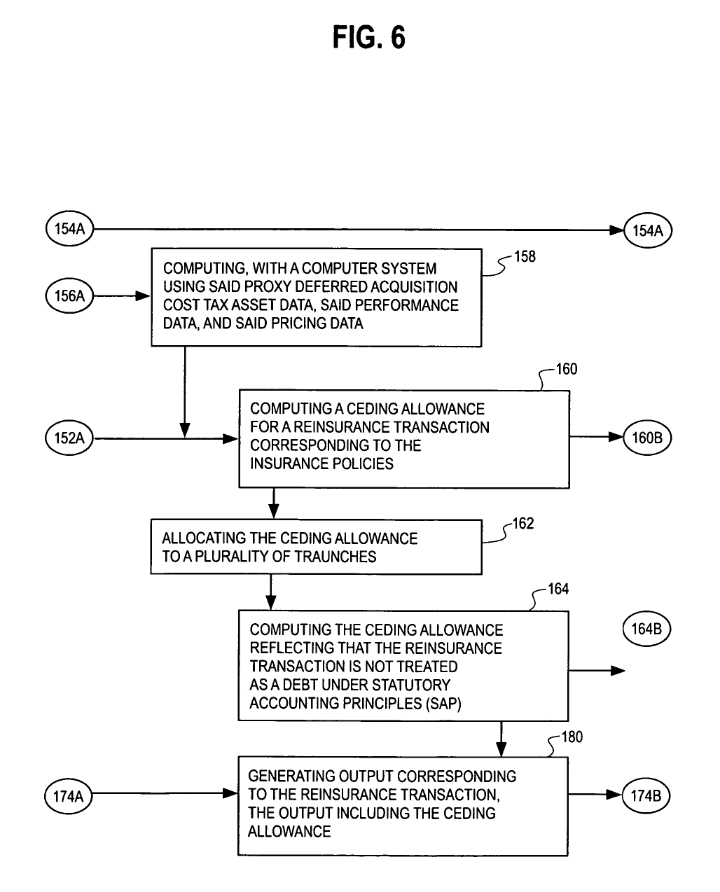

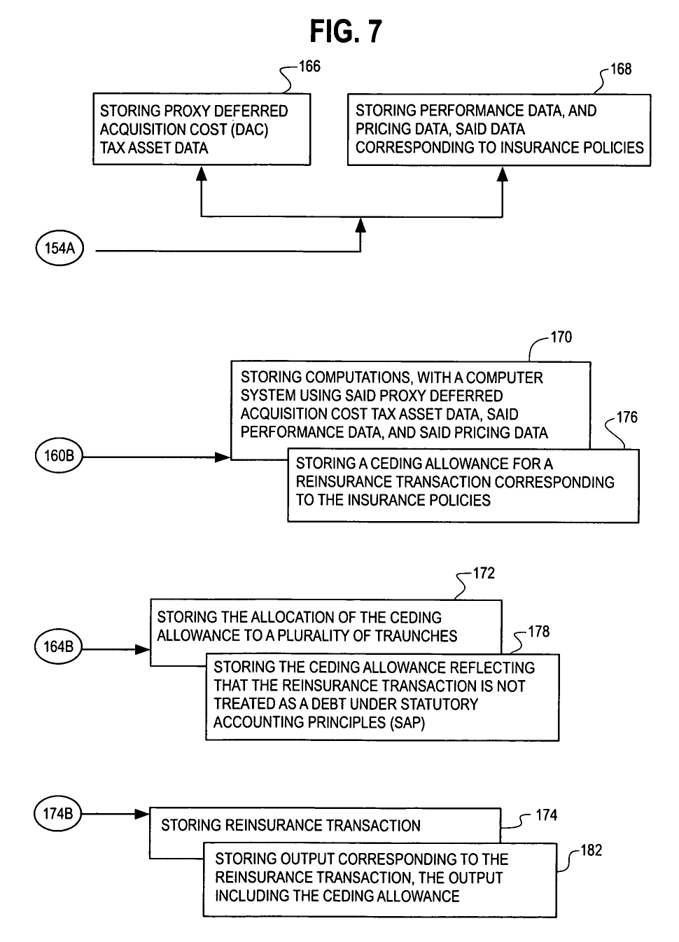

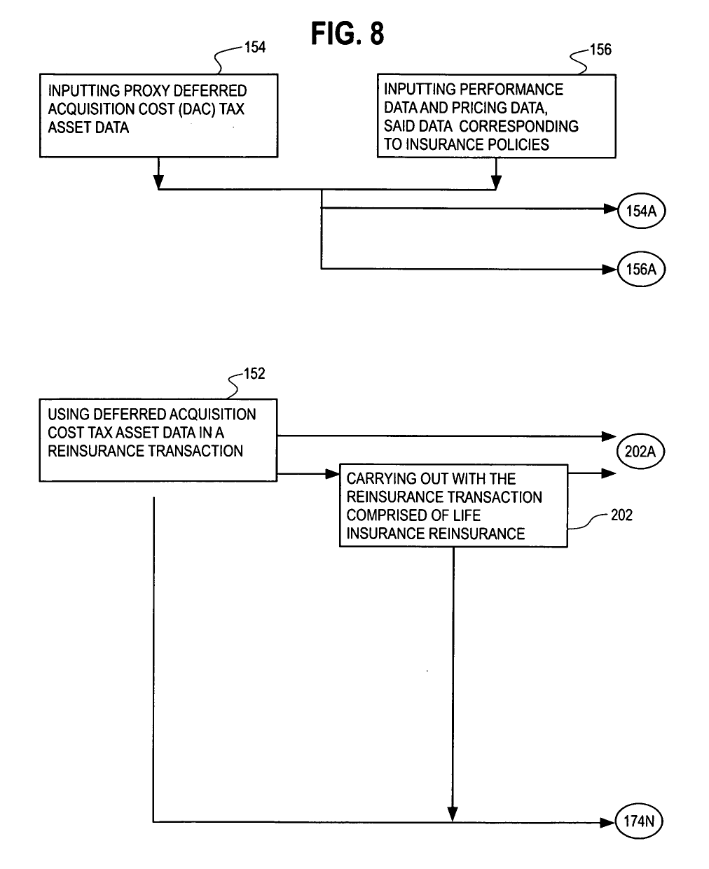

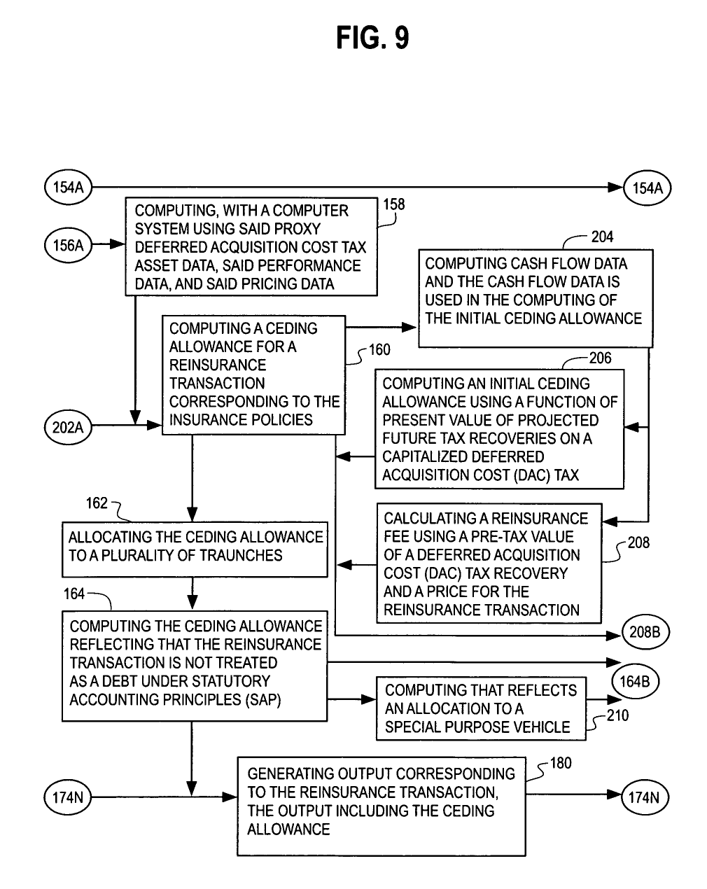

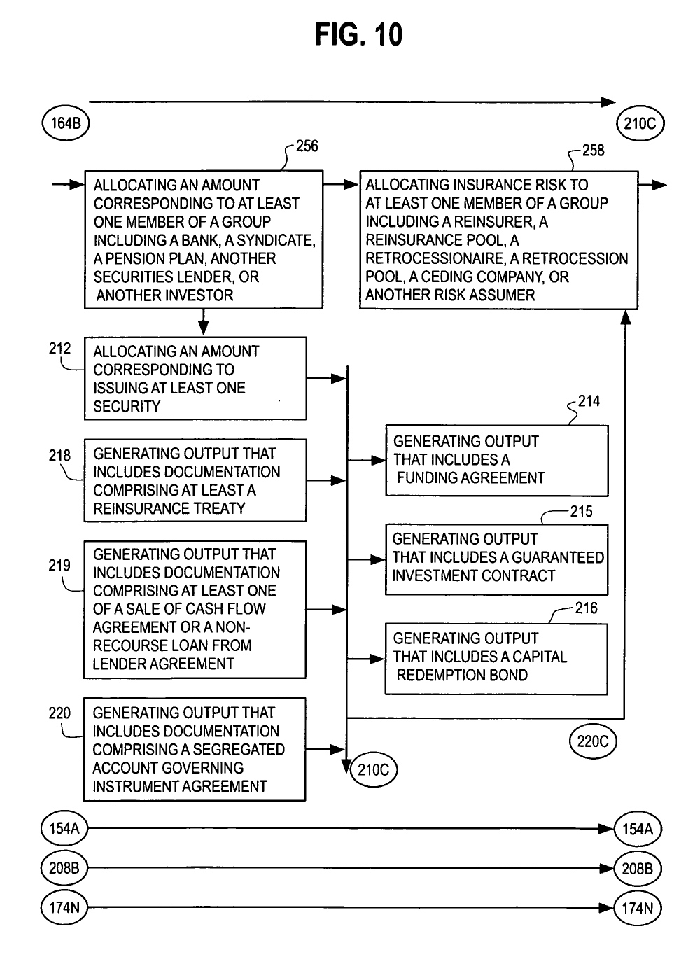

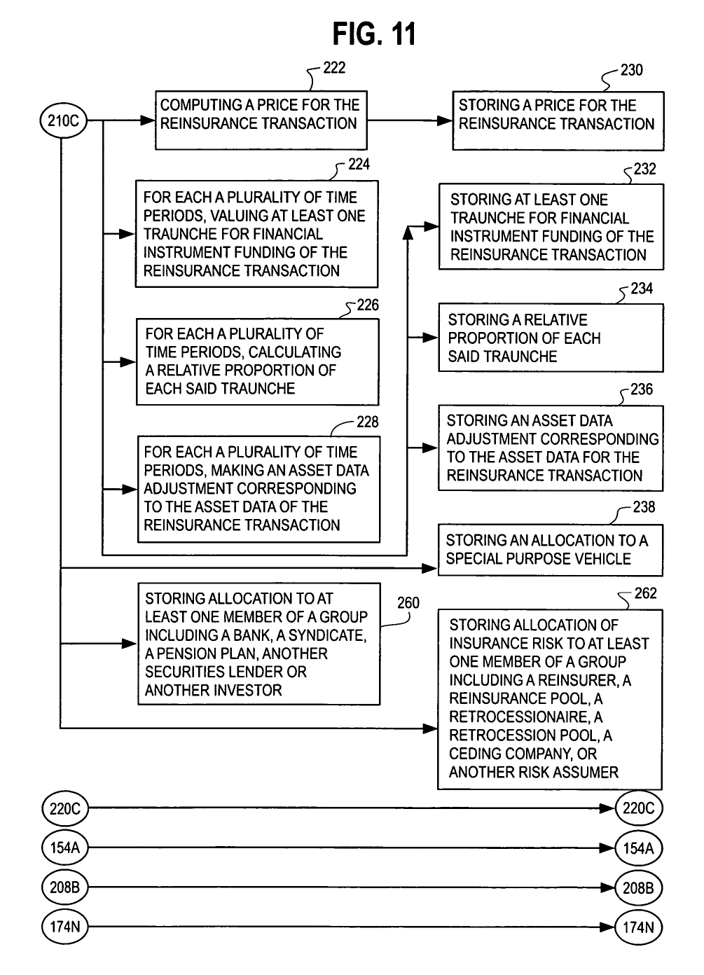

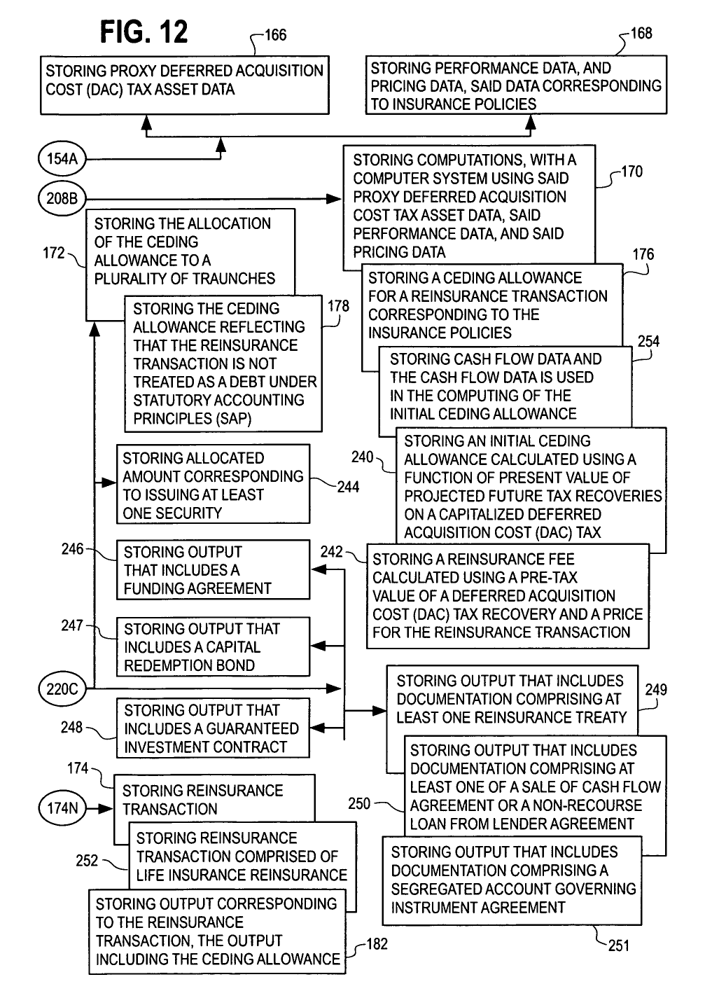

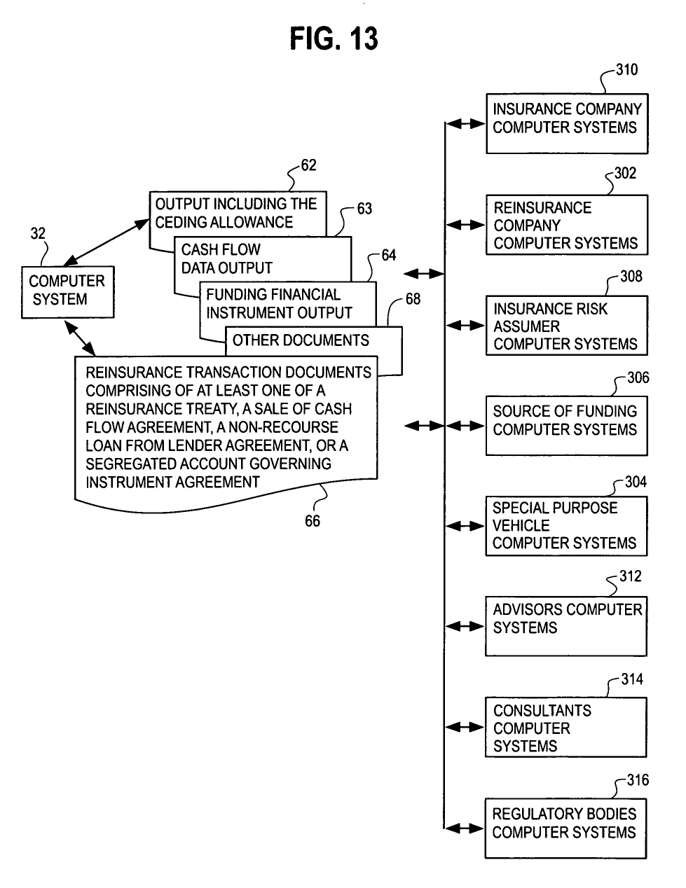

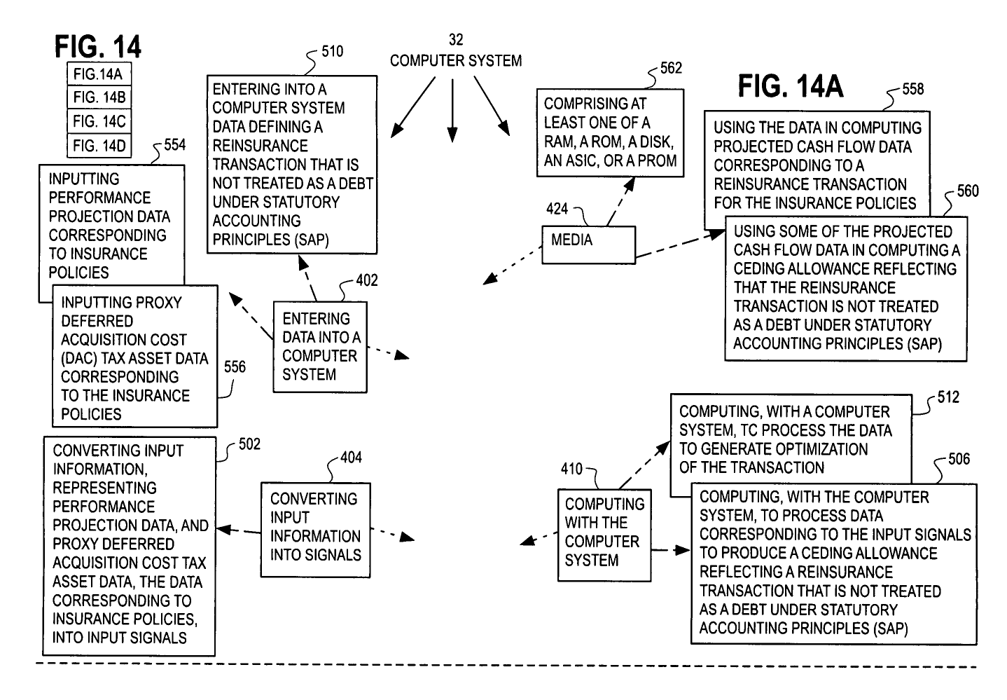

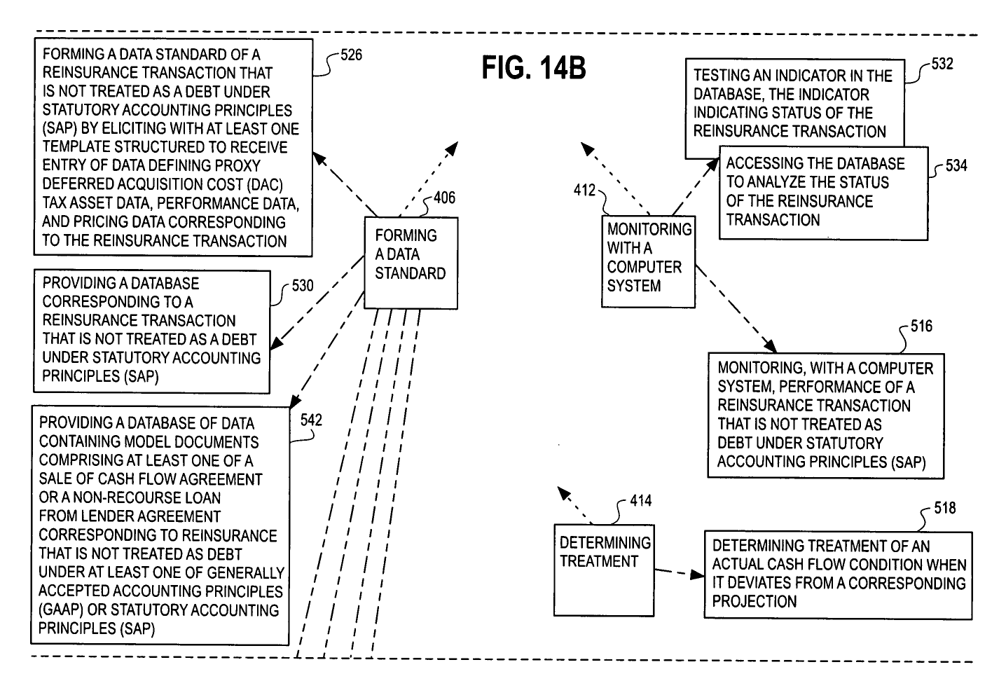

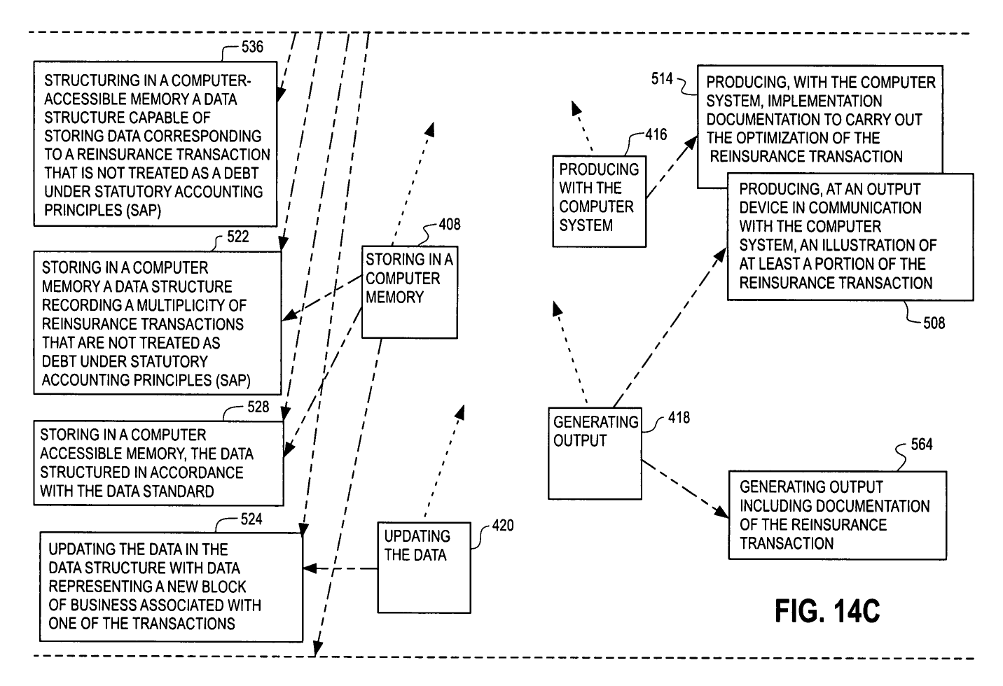

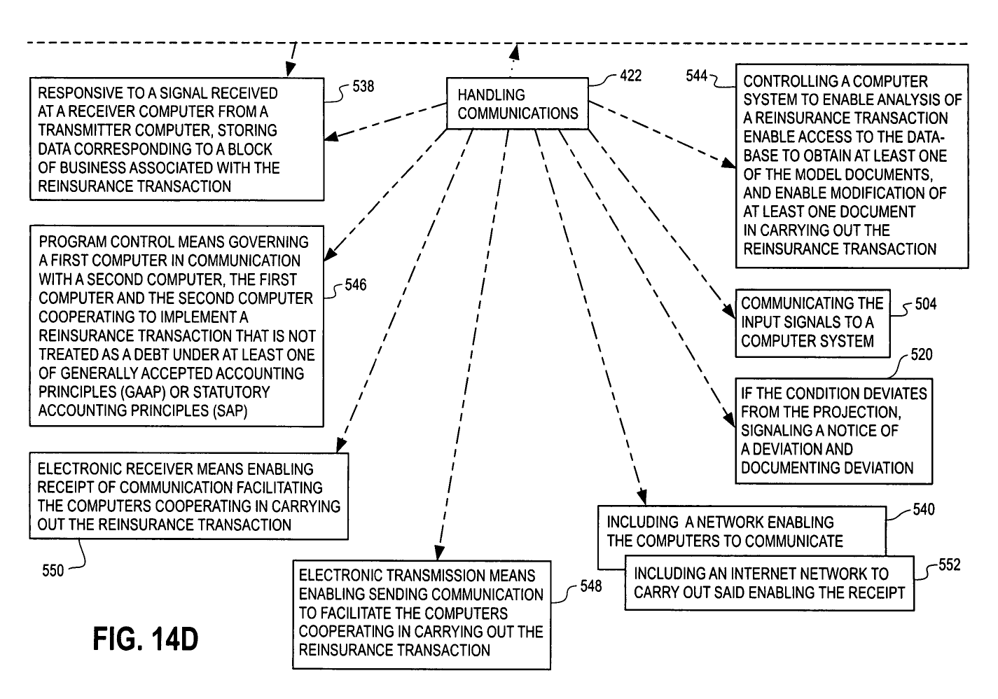

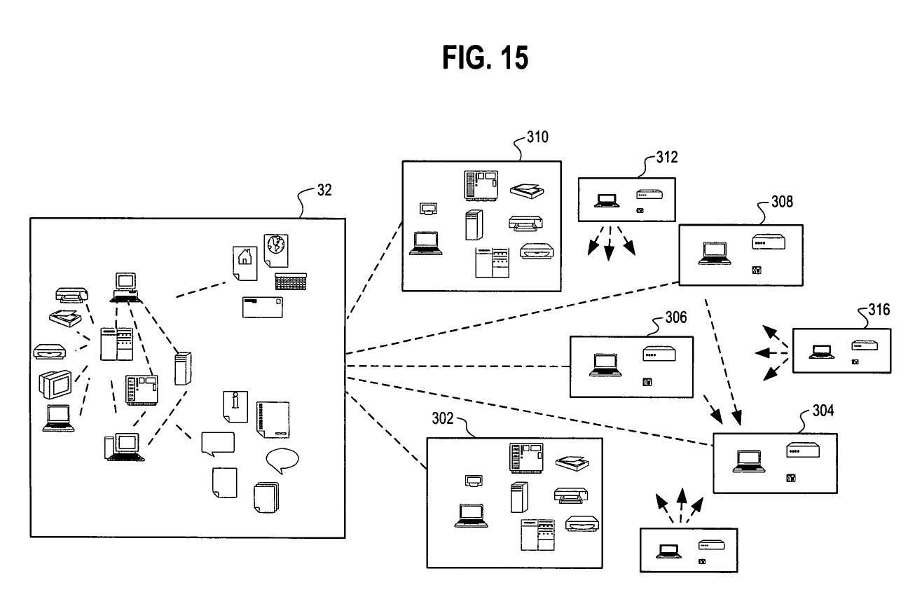

FIG. 1 is to teach by way of a representative configuration. There can be one or more end user stations 100, each for a visitor (not shown). At least one of the end user stations 100 can include a digital computer with a processor (such as an Intel Pentium or Centrino processor), a memory, an input device (such as a keyboard, mouse, speech recognizer, disk or CD drive, computer-to-computer communication device, etc.), and an output device (such as a monitor, printer, disk or CD drive, or a computer-to-computer communication device as in the illustration of a modem 120 in FIG. 1). The memory can include an operating system such as Windows or Linux to run the user station 100, for example, enable application(s) software.

A user station 100 can use its computer-to-computer communication device 120 to communicate via wide area network 110, such as the Internet, where a user station 100 can interact with a search engine 130. The search engine 130 can facilitate a search of content on the WAN 110 (or content stored therefrom). Search results are communicated back to the user station 100, including such as a.html 140 and b.html 150. The a.html 140 and b.html 150 portions be webpages, websites, or portions of web page 160 that handles encryption 180, scrambling, or the like. One, but not the only, manner of carrying out a.html is via a housing 190 to a.html 140 that enables authorization (see, for example, the discussion herein of log in pages to get cookies, taking into consideration that other modes authorization can be used, e.g., digital signature). The handling of the authorization can be carried out in connection with a proxy system 200. Authorization can be provided affirmatively, for example affirmatively granted based on receipt of a payment from the visitor or upon receiving proof of the age of the visitor (i.e., not a minor), or negatively, e.g., unblocking a censorship or parental control.

A representative way of understanding the functioning, again noting that this discussion is intended to teach broader concepts via representative illustration, is that web page 160 can have a script or a program represented at authorization 190 to handle a request to fetch an authentication-required web page 160. The script or program checks whether the request has correct authentication information, such as a right pair of right username and password or otherwise, depending on the manner of implementation preferred. (An authorization check can be made by checking the username and password, cookies, IP address or other information in the request.) If the request has the correct authentication information, the requested a.html webpage will be returned to the user device 100. If the request does not have correct authentication information, an encrypted page of the requested web page, b.html, will be returned to the user device 100 with a redirection header. The redirection header can be such as:

<HEAD>
<META HTTP-EQUIV=″Refresh″ CONTENT=″5; URL=newlogin.pl”>
</HEAD>

Note that when the file type, such as a dot txt file, does not support redirection, a link can be added in the content explicitly to let user to manually link to the right web page.

The redirection header can bring the user to an authentication page via the proxy system 200 for user to login. Because the inhibited or encrypted web page a.html is reachable by search engine 130, the content can be used for searching. If a user finds this web page 160 by search engine 130 and requests this web page 130, the inhibited or encrypted web page a.html will be sent to the user, and the request will be redirected to the authentication-required web page at proxy system 200.

As previously noted herein, different embodiments can be used to allow the search engine to find the page but inhibit reading of the page. Thus, for example, the inhibited or encrypted versions can be done with sentence-inhibited or encrypted, or word-inhibited or encrypted implementations. Both sentence-inhibited or encrypted and/or word-inhibited or encrypted files can be generated with perl, php, c or other program. Suitable algorithms can be random or some special encrypt algorithm, depending on the implementation preference. For sentence-encryption, one algorithm can keep the word order between sentence characters unchanged and reorder the sentences. For word-inhibited or encryption, the algorithm can keep the letter order in each word untouched and reorder the words. The inhibited or encrypted file can be generated on-fly or off line. The inhibited or encrypted files can be stored in directories which do not require authorization and the files can be reachable by one or more search engines. Note that both word and sentence inhibited or encryption versions of the content can be provided at web page 160.

Certain embodiments can be applied to websites with adult contents, such as gambling. For the adult web site, embodiments can function consistent with the teachings herein. If a visitor sends a request for a web page without authorization, the web site can return a word-order-encrypted content without explicit pictures. A link to the authorization page/site can be included either in a redirection or other ways. The site can independent of the authorizing site, so for example, a visitor can go to one site and obtain authorization (e.g., a cookie) that can be used at one or more sites, e.g., authorization indicating that the visitor's age is adult rather than minor. By being able to get one authorization valid at other independent sites, the visitor need not participate in site-by-site authorization.

Applications consistent with the teachings herein can include downloads, video, sound, radio, TV, movie, film music, etc. and any other things in which content comprehension is limited to those who are authorized. Once the content can be comprehended by the authorized visitor, sufficient information can be comprehended by a human user so that downloading, or essentially real time communication such as streaming or Internet radio, can be carried out.

Yet another application is media searching, which is entirely comprehended as being within the scope of the teaching herein. For example, the movies, the order of the frames are important and critical for human to understand them. A search engine can be adapted to search by looking the frames. A frame-re-ordered film can be searchable to such a search engine but not understandable or enjoyable to a human. Of course, the frame-re-ordered film can be open to public for an un-authorized user.

The concept in this embodiment is, of course, broader: if there is authorization, provide a version of the content that comprises data in a particular order; and if there is not authorization, provide a version of the content that comprises a different order of at least some of the data; and where appropriate, facilitate authorization. The same applies to word scrambling and/or sentence scrambling.

Still another embodiment is to provide the visitor with a code, as an example of an authorization technique. All adult content pages are inhibited or encrypted in a way that the content can be comprehended by the visitor only by using the code. Un-authorized users do not have such a code, and cannot understand the content. A user with such a code can read the content at one, or any of the websites that are provided with the code by the authenticating entity. A simple code, however, is moiré readily hackable than other embodiments herein, so a readily changing code, e.g., applying a date or otherwise changing variable in an equation that produces and recognizes the code is more secure.

Yet still another application can be directed not to a web page, but to such as advertising or a pop-up. For example, imagine an adult content pop-up that can display only if a cookie identifies the user, or user's device, as an adult. An adult indicator such as a cookie is one of many ways consistent herein to enable human-comprehensible content to be displayed; and one such cookie may suffice to enable such content from a plurality of sources adapted to test for the presence of the cookie or other indicator of authority to view the content in a human-comprehensible format. In such an embodiment, there need not be a display of the inhibited content at all; rather the authorization (e.g., cookie) acts as a switch to allow display of the content.

Note too, that there can be layers of authorization, so for example one cookie might enable seeing some uninhibited content (e.g., at a web site), and another authorization can be required for still further uninhibited content at that web site, thereby having layers of authorization and versions of the content.

Further embodiments can include computer-readable media tangibly embodying a program of instructions executable by a computer to perform the operations discussed herein. The media can include at least one of a RAM, a ROM, a disk, an ASIC, or a PROM. A carrier wave is viewed as comprising a storage media.

Each user station 100 can be viewed as an embodiment separately or in combination with one or more teachings from FIG. 110. The user station can initiate authentication and receiving authentication data located at user station 100, e.g., a cookie enabling receipt of content from the web page 160. The content is one of at least two versions of the content, such as a.html and b.html. The prior authentication is at least in part determinative of the version received. Access to the uninhibited or unencrypted version can be such as to have the inhibited or encrypted page explicitly contain a link to the uninhibited or unencrypted web page. Or there can be a redirection in the inhibited or encrypted page that will redirect the visitor to the uninhibited or unencrypted webpage. Or both of these approaches can be used. Because the uninhibited or unencrypted web page has an authorization-required location, an unauthorized visitor will see a login page. After successfully logging, the visitor can see the uninhibited or unencrypted page.

Viewed from a different perspective, web page 160 facilitates at least two versions of content: one version is of the kind that would permit a search engine to find it, but that would inhibit comprehension by a visitor; an other version would not inhibit human comprehension of the content.

Accordingly, some embodiments can be viewed as including, depending on the implementation, apparatus, a method for use and method for making, and corresponding products produced thereby, as well as data structures, computer-readable media tangibly embodying program instructions, manufactures, and necessary intermediates of the foregoing. Representatively, consider an embodiment characterized as a method for using an apparatus.

More broadly, however, the terms and expressions which have been employed herein are used as terms of teaching and not of limitation, and there is no intention, in the use of such terms and expressions, of excluding equivalents of the features shown and described, or portions thereof, it being recognized that various modifications are possible within the scope of the embodiments contemplated and suggested herein. Although the disclosure herein has been described with reference to specific embodiments, the disclosures are intended to be illustrative and are not intended to be limiting. Various modifications and applications may occur to those skilled in the art without departing from the true spirit and scope of the invention as defined in claims.

Thus, although only a few exemplary embodiments have been described in detail above, those skilled in the art can readily appreciate that many modifications are possible in the exemplary embodiments without materially departing from the novel teachings and advantages herein. Accordingly, all such modifications are intended to be included within the scope defined by claims. As used herein, means-plus-function is intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

I claim:

1. A computer-aided method of providing content to a user device, the method including:
providing one of two versions of content to a user device, based on authorization:
if the user device communicates an authorization, presenting content at the user device in a first version that does not inhibit human comprehension; and
if the user device does not communicate authorization, presenting the content at the user device in a second version that inhibits human comprehension and allowing the authorization to be obtained.

2. The method of claim 1, wherein said presenting the second version includes presenting the second version in results of a search engine.

3. The method of claim 2, wherein the results are provided over the Internet.

4. The method of claim 3, wherein the versions differ by word order.

5. The method of claim 3, wherein the versions differ by sentence order.

6. The method of claim 3, wherein the versions differ by both sentence order and sentence order.

7. The method of claim 3, wherein the versions differ by encryption.

8. The method of claim 3, wherein said allowing the authorization to be obtained includes providing a redirect to a web page adapted to provide the authorization.

9. The method of claim 8, wherein the web page is adapted to provide the authorization is based, at least in part, on age.

10. The method of claim 8, wherein the web page is adapted to provide the authorization is based, at least in part, on payment received for the authorization.

11. The method of claim 3, wherein said allowing the authorization to be obtained includes providing a link to a web page adapted to provide authorization.

12. The method of claim 8, wherein the authorization includes a cookie.

13. The method of claim 8, wherein the authorization includes a code.

14. The method of claim 3, wherein the versions of content are provided from a web site, and the authorization allows viewing other content at a different web site.

15. The method of claim 3, further including:
generating the second version as a web page statically; and
saving the web page so that it can be reached by at least one search engine.

16. The method of claim 3, further including
generating the second version dynamically, in response to a search request.

17. A system controlling content versions communicated to a user device, the system including:
a computer system programmed to respond to a search engine by testing whether a user device is authorized to receive one of two versions of the content, and
if there is authorization, provide a version of the content that comprises data in order; and
if there is not authorization, provide a version of the content that comprises a different order of at least some of the data and facilitate authorization.

18. The system of claim 17, wherein the computer system includes a web site; and further including an end user device, receiving over the Internet a search result from a search engine, the search result corresponding to the second version, wherein said second version uses all words of the first version but not the order of the words.

19. The system of claim 17, wherein the computer system includes a web site; and
further including an end user device, receiving over the Internet a search result from a search engine, the search result corresponding to the second version, wherein said second version uses all sentences of the first version but not not the order of the sentences.

20. The system claims 17, wherein:
the computer system provides, with the second version, a redirection link an authentication-required web page.

21. The system of claim 17, wherein:
the computer system dynamically generates the second version in response to a search request from a search engine.

22. The system of claim 17, wherein:
the computer system generates, statically, the second version as a web page and
saves the encrypted web page so that it can be reached by the search engine.

23. A system of computers able to cooperate over an Internet-type network, the system including:
a computer system arranged to receive information and locate said information into a memory, the information including a first version of web site content, the computer system further including an input device for receiving the information and converting the information into signals and a program control to automatically computing, from said signals, a second version of the content, wherein the first version of the content does not inhibit human comprehension, and the second version of the content inhibits human comprehension;
a plurality of end user devices adapted for searching the network with at least one respective search engine; wherein the computer system provides the second version to the search engine without authorization, and the first version with authorization.

24. An Internet search engine system, the system including:
a search engine capable of searching web pages on the Internet; and
a user device communicating to the search engine, the communicating including sending data to be searched by the search engine and receiving at least one result of the search from the search engine;
wherein said at least one result includes one of two versions of content, a first version of web site content that does not inhibit human comprehension, and the second version of the content inhibits human comprehension, wherein the version corresponding to the result is based, at least in part, on whether the user device communicates authorization corresponding to the first version.

25. A computer-readable media tangibly embodying a program of instructions executable by a computer to perform the operations of:
presenting a version of content in response to a search request, a first version being provided responsive to communication of user authorization, and a second version that inhibits human comprehension in the absence of said authorization.

26. The media of claim 25, wherein the media comprises at least one of a RAM, a ROM, a disk, an ASIC, and a PROM.

27. A computer system providing content on an Internet-type network, the system including:
a search engine allowing web pages to be found over the Internet-type network;
a user device adapted to communicate a search request to the search engine;
a server providing at least one web page;
means for controlling the server to present the search engine with one version of content responsive to communication of user authorization or a second version of the content inhibited for human comprehension in the absence of the authorization.
